(19) United States
(12) Patent Application Publication
(10) Pub. No.: US 2026/0353147 A1
(43) Pub. Date: Nov. 5, 2026

(54) CONDITIONAL TRIGGER-BASED RVQoE REPORTING

(71) Applicant: Telefonaktiebolaget LM Ericsson (publ), Stockholm (SE)

(72) Inventors: Agne Åberg Larsson, Uppsala (SE); Luca Lunardi, Genoa (IT); Johan Rune, Lidingö (SE); Filip Barac, Huddinge (SE)

(21) Appl. No.: 19/487,065

(22) PCT Filed: May 22, 2024
(86) PCT No.: PCT/IB2024/054994

§ 371 Date: Nov. 24, 2025

Related U.S. Application Data
(60) Provisional application No. 63/468,136, filed on May 22, 2023.

(51) Int. Cl. H04W 24/10

(52) U.S. Cl. CPC H04W 24/10

(57) ABSTRACT

A method for configuring a User Equipment (UE) to perform conditional trigger-based Radio Access Network Visible Quality of Experience (RVQoE) reporting in a wireless communications system. A network node of a Radio Access Network (RAN) can configure a UE to perform RVQoE reporting when a triggering criterion is met in a time period of observation. A UE Application layer can perform the QoE measurements and then either determine whether the triggering criterion for performing RVQoE reporting has been met based on the measurements, or the UE Application layer can pass the measurements to the UE Access Stratum layer which can determine whether the triggering criterion has been met. The UE can then provide the RVQoE report to the network node.

### RELATED APPLICATIONS

This application claims the benefit of provisional patent application Ser. No. 63/468,136, filed May 22, 2023, the disclosure of which is hereby incorporated herein by reference in its entirety.

### TECHNICAL FIELD

The present disclosure relates to a method for configuring a User Equipment to perform conditional trigger-based Radio Access Network Visible Quality of Experience (RVQoE) reporting in a wireless communications system.

### BACKGROUND

### Legacy QoE Measurements

Quality of Experience (QoE) measurements, also referred to as “application layer measurements”, have been specified for Long Term Evolution (LTE), Universal Mobile Telecommunications System (UMTS) and were recently specified for Fifth Generation (5G) New Radio (NR) in the Third Generation Partnership Project (3GPP) Rel-17. The purpose of the QoE measurements is to measure the experience of the end user using certain applications. Currently the QoE measurements are specified and supported for DASH streaming, MTSI (Mobility Telephony Service for Internet Protocol (IP) Multimedia Subsystem ((IMS)) services, and Virtual Reality (VR).

The solutions in LTE and UMTS are similar with the overall principles as follows. QoE Measurement Collection (QMC) enables configuration of application layer measurements in the User Equipment (UE) and transmission of QoE measurement result files, commonly referred to as “QoE reports”, to the network by means of Radio Resource Control (RRC) signaling. An application layer measurement configuration (also called QoE measurement configuration or QoE configuration) that the Radio Access Network (RAN) receives from the Operations, Administration, and Maintenance (OAM) system, or the core network (CN), is encapsulated in a transparent container, which is forwarded to a UE in a downlink RRCReconfiguration message. An application layer measurement report (also called QoE report) that the UE Access Stratum (UE AS) or UE RRC layer receives from the UE's higher layer (application layer) is encapsulated in a transparent container and sent to the network in an uplink RRC message, MeasurementAppLayerReport. The RAN then forwards the QoE report to a Measurement Collector Entity (MCE).

In 3GPP Rel-17 “Study on NR QoE management and optimizations for diverse services” the purpose to study solutions for QoE measurements in NR was finalized and concluded. According to this item, QoE management in NR will not just collect the QoE parameters of streaming services but also consider the typical performance requirements of diverse services (e.g., Augmented Reality/Virtual Reality “AR/VR” and Ultra-Reliable Low Latency Communications “URLLC”, of which at least VR was covered in 3GPP Rel-17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity the collected measurement results (i.e. the QoE reports) should be sent to (often referred to as a MCE, spelled out as Measurement Collector Entity or Measurement Collection Entity) and a set of instructions of which type of measurements that should be performed and details of how these measurements are to be performed. These instructions are intended for the application layer in the UE and are placed in a “container” which cannot be read and interpreted by the network entities handling it, e.g., forwarding it to the UE, as well as the UE Access Stratum. The currently specified service types are MTSI and streaming service (DASH), and in 3GPP Rel-17, VR was added. An area scope is defined in terms of cells or network related areas. In UMTS, an area scope is defined as either a list of cells, a list of routing areas, or a list of tracking areas. In LTE, an area scope is defined as either a list of cells or a list of tracking areas. In NR, an area scope is defined as either a list of cells (a list of NCGIs) or a list of tracking areas (a list of TACs).

QoE, and in particular, the QoE configuration, comes in two flavors: management-based (m-based) QoE configuration and signaling-based (s-based) QoE configuration. In both cases the QoE configuration originates in the OAM system or some other administrational entity, e.g., dealing with customer satisfaction. All of these entities are in this document referred to as the OAM system (where the OAM system also contains further entities).

With the m-based QoE, the OAM system is typically interested in general QoE statistics from a certain area, configured as an area scope. The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With the s-based QoE, the OAM system is interested in collecting QoE measurement results from a specific UE, e.g., because the user of the UE has filed a complaint. The OAM system sends the s-based QoE configuration to the Home Subscriber Server (HSS) (in Evolved Packet System (EPS)/LTE) or Unified Data Management (UDM) (in 5GS/NR), which forwards the QoE configuration to the UE's current core network node (CN), e.g., an MME in EPS/LTE or an AMF in 5G/NR. The Core Network (CN) then forwards the s-based QoE configuration to the RAN node that serves the concerned UE, and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality is logically separated from the Trace functionality, but it will still partly reuse the Trace signaling mechanisms. In NR, and possibly in LTE, a globally unique QoE reference (formed of MCC+MNC+QMC ID, where the QMC ID is a string of 24 bits) will be associated with each QoE configuration. The QoE reference is included in the container with measurement instructions and also sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE reports are sent from the UE application layer to the UE Access Stratum, which forwards them to the RAN, which in turn forwards them to the MCE. These QoE reports are placed in a “container”, which is uninterpretable for both the UE Access Stratum and the RAN. QoE reporting can be configured to be periodic or only to be sent at the end of an application session. Furthermore, the RAN can instruct the UE to pause QoE reporting, e.g., in case the cell/gNB is in a state of overload.

The RAN is not automatically aware of when an application session with an associated QoE measurement session is ongoing, and the UE Access Stratum is also not automatically aware of this. To alleviate this session “start”/“stop” indications which are sent from the application layer in the UE to the UE AS and from the UE AS to the RAN were introduced. A session “stop” indication may be explicit or may be implicit in the form of a QoE report sent when the application session and the associated QoE measurement session are concluded.

The RAN may decide to release a QoE configuration in a UE at any time, as an implementation-based decision. Typically, it is done when the UE has moved outside a configured area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### RAN Visible QoE (RVQoE) Measurements

QoE measurements, and their reported results, are intended for analysis in the O&M system (or in other entities that neither belong to the core network nor belong to the RAN) and subsequent possible non-real-time optimizations. The QoE reports are forwarded transparently by the RAN to a configured receiver, e.g., an MCE. However, the RAN could also benefit from receiving measurement results of metrics measured or collected at the application layer, e.g., as a complement to the more radio related measurements, i.e. the RRM measurements (e.g., Reference Signal Received Power “RSRP”, Reference Signal Received Quality “RSRQ”, and Signal to Interference and Noise Ratio SINR . . . ). For instance, the RAN could use such measurement results for real-time or semi-real-time adaptations or optimizations of the treatment of an ongoing application session, e.g., in terms of scheduling priorities.

For this reason, in 3GPP release 17, 3GPP introduced so-called RAN Visible QoE, which comprises periodic reporting of measured application layer metrics in a format that the RAN can understand. These metrics, denoted as RVQoE metrics, are in release 17 limited to QoE metrics, in particular the Buffer Level QoE metric for DASH (specified in 3GPP TS 26.247 version 17.1.0, which in turn references annex D.4.5 in ISO/IEC 23009-1, and represented in 3GPP TS 38.331 version 17.2.0 (i.e. the RRC specification) as the AppLayerBufferLevel-r17 field) and the Playout Delay for Media Start-up QoE metric for DASH (specified in 3GPP TS 26.247 version 17.1.0 and represented in 3GPP TS 38.331 version 17.2.0 (i.e. the RRC specification) as the playoutDelayForMediaStartup-r17 field). In addition to these two RVQoE metrics, a MeasurementReportAppLayer message may contain a PDU session ID list (in the form of the pdu-SessionIdList-r17 field) as part of the reported RVQ information (i.e., in the RAN-VisibleMeasurements-r17 IE).

The configuration for QoE and RVQoE are performed via an RRC reconfiguration message containing the AppLayerMeasConfig information element. The configuration of legacy QoE metrics is done via the measConfigAppLayerContainer IE, which specifies the configuration to the application-layer in the UE as an octet string (following XML). RVQOE parameters are specified as part of the RAN-VisibleParameters IE.

```
-- ASN1START
-- TAG-APPLAYERMEASCONFIG-START
AppLayerMeasConfig-r17 ::= SEQUENCE {
  measConfigAppLayerToAddModList-r17 SEQUENCE (SIZE (1..maxNrofAppLayerMeas-r17)) OF
MeasConfigAppLayer-r17 OPTIONAL, -- Need N
  measConfigAppLayerToReleaseList-r17 SEQUENCE (SIZE (1..maxNrofAppLayerMeas-r17)) OF
MeasConfigAppLayerId-r17 OPTIONAL, -- Need N
  rrc-SegAllowed-r17 ENUMERATED {enabled}
OPTIONAL, -- Need R
  ...
}
MeasConfigAppLayer-r17 ::= SEQUENCE {
  measConfigAppLayerId-r17 MeasConfigAppLayerId-r17,
  measConfigAppLayerContainer-r17 OCTET STRING (SIZE (1..8000))
OPTIONAL, -- Need N
  serviceType-r17 ENUMERATED {streaming, mtsi, vr, spare5, spare4, spare3, spare2,
spare1} OPTIONAL, -- Need M
  pauseReporting-r17 BOOLEAN OPTIONAL, --
Need M
  transmissionOfSessionStartStop-r17 BOOLEAN
OPTIONAL, -- Need M
  ran-VisibleParameters-r17 SetupRelease {RAN-VisibleParameters-r17}
OPTIONAL, -- Cond ServiceType
  ...
}
RAN-VisibleParameters-r17 ::= SEQUENCE {
  ran-VisiblePeriodicity-r17 ENUMERATED {ms120, ms240, ms480, ms640, ms1024}
OPTIONAL, -- Need S
  numberOfBufferLevelEntries-r17 INTEGER (1..8)
OPTIONAL, -- Need R
  reportPlayoutDelayForMediaStartup-r17 BOOLEAN
OPTIONAL, -- Need M
  ...
}
-- TAG-APPLAYERMEASCONFIG-STOP
-- ASN1STOP
```

### Support of Event-Based RVQoE Reporting

As part of Rel-18 normative work, the RAN3 Working Group is discussing the support for triggered based and event-based RVQoE reporting.

Until now, one threshold-based trigger for RVQoE reporting has been agreed, that is based on buffer level, while another threshold-based trigger for reporting playout delay for media startup has not been agreed.

In terms of event-based RVQoE reporting trigger, some proposals have been made, for example to report RVQoE measurements upon fulfillment of radio related events (as defined in 3GPP TS 38.331 v17.3.0), and no agreements have been settled so far.

In terms of RVQoE reporting, a gNB can configure the UE to report RVQoE measurements based on a certain periodicity (as defined by the ran-VisiblePeriodicity IE in TS 38.331).

In one contribution to RAN3 119 meeting (R3-230371) it has been proposed to consider three different options for determining the buffer level measurement periodicity:
In Rel-17, the buffer level measurement periodicity is calculated by the UE APP as the buffer level reporting periodicity divided by numberOfBufferLevelEntries. But if threshold-based reporting for buffer level is configured by NG-RAN node in Rel-18, it might not configure the reporting periodicity.
Proposal 5: RAN3 should confirm that ran-VisiblePeriodicity (reporting periodicity) will not be configured in case threshold-based triggers are used for reporting RVQoE metrics (e.g., buffer level).
If Proposal 5 is agreed, then it is not clear how frequently that the buffer level should be measured at UE APP for RVQoE reporting.
By default, the buffer level will be measured every n seconds (as configured by the container-based QoE) and can be measured more frequently (ran-VisiblePeriodicity divided by numberOfBufferLevelEntries) in case periodic reporting is configured. In case of threshold-based reporting, the following options can be considered for determining the buffer level measurement periodicity:
   Option 1: NG-RAN explicitly configures the buffer level measurement periodicity in case threshold-based triggers are configured
   Option 2: Same as configured by the container-based QoE (every n seconds)
   Option 3: Up to UE implementation

In several contributions in the RAN2 #119bis meeting (R2-2209837 and R2-2209845) there were proposals addressing one of the key issues to enable the event-triggered RVQoE reporting, i.e., which of the layers, UE AS or UE application layer, should be detecting and performing evaluation of RVQoE events for the reporting:

R2-2209837: Among many topics on definition of the event(s) two options can be considered:
Option 1) AS layer is responsible for detecting event(s) to trigger RVQoE report.
Option 2) Application layer is responsible for detecting event(s) to trigger RVQoE report.

In option 1, the AS layer may use Received Signal RSRP or RSRQ measurement to detect events. After detecting an event, the AS layer may need to inform event detection to the application layer so that the application layer triggers RVQoE measurement. In option 2, the application layer may use application level QoE metric to detect events. For instance, if the application layer detects low buffer level, it can trigger RVQoE measurement.

Proposal 2. Discuss which Layer (AS or Application) is Responsible to Detect Event(s) for RVQoE Report.

R2-2209845: Another issue is which layer should perform the event evaluation. It could be an application layer or AS layer. If in application layer, then the AS layer should forward the configured event parameters to application layer; if in AS layer, similar as current radio measurement that RRC will evaluate event based on the received radio measurement result from L1, the RRC layer will evaluate the event based on the received BufferLevel or PlayoutDelay measurement result, and trigger RVQoE report.

Proposal 5: RAN2 Discusses which Layer (Application Layer or RRC Layer) Performs RVQoE Event Evaluation.

Furthermore, RAN2 has received a reply LS from the 3GPP TSG-SA WG4 meeting #123-e about the buffer level threshold-based RVQoE reporting. In this reply SA4 discusses the preference towards the application layer triggers buffer level threshold-based RVQoE reporting, as (1) a mechanism enabling the application layer to be configured for QoE reporting already exists before the Release 18, and could be reused for the threshold-triggered RVQoE reporting, and (2) the application layer is faster to make threshold-based decisions than UE AS layer, and hence report the buffer level threshold being reached with a smaller delay than the UE AS would report.

### SUMMARY

The present disclosure relates to a method for configuring a User Equipment (UE) to perform conditional trigger-based Radio Access Network Visible Quality of Experience (RVQoE) reporting in a wireless communications system. A network node of a Radio Access Network (RAN) can configure a UE to perform RVQoE reporting when a triggering criterion is met in a time period of observation. A UE Application layer can perform the QoE measurements, and then either determine whether the triggering criterion for performing RVQoE reporting has been met based on the measurements, or the UE Application layer can pass the measurements to the UE Access Stratum layer which can determine whether the triggering criterion has been met. The UE can then provide the RVQoE report to the network node.

In an embodiment, a method performed by a UE for performing conditional event-based RVQoE reporting can include receiving, from a network node, an RVQoE configuration that indicates a time period of observation and a triggering criterion for performing RVQoE reporting. The method can also include determining that the triggering criterion for performing the RVQoE reporting has occurred during the time period of observation. The method can also include providing, to the network node, an RVQoE report indicating that the triggering criterion has occurred during the time period of observation.

In an embodiment, the determining further includes measuring, by a UE Application Layer, one or more metrics associated with the triggering criterion, determining, by the UE Application Layer, based on measurements of the one or more metrics, that the triggering criterion has occurred, and indicating, by the UE Application Layer, to a UE Access Stratum Layer to provide the RVQoE report to the network node.

In an embodiment, the indicating further comprises indicating triggering criterion information that comprises measurement information associated with the triggering criterion.

In an embodiment, the providing the RVQoE report to the network node is performed by the UE Access Stratum Layer, and the RVQoE report indicates that the triggering criterion has occurred.

In an embodiment, the providing the RVQoE report to the network node is performed by the UE Access Stratum Layer, and the RVQoE report indicates that the triggering criterion has occurred, and the RVQoE report comprises the measurement information associated with the triggering criterion.

In an embodiment, the determining further includes measuring, by a UE Application Layer, one or more metrics associated with the triggering criterion; and providing, by the UE Application Layer, measurements of the one or more metrics to a UE Access Stratum Layer; and determining, by the UE Access Stratum Layer based on the measurements of the one or more metrics, that the triggering criterion has occurred.

In an embodiment, the providing the RVQoE report to the network node is performed by the UE Access Stratum Layer, and the RVQoE report indicates that the triggering criterion has occurred.

In an embodiment, the RVQoE report comprises the measurement information associated with the triggering criterion.

In an embodiment, the determining that the triggering criterion for performing the RVQoE reporting has occurred during the time period of observation is performed after the time period of observation has elapsed.

In an embodiment, the determining that the triggering criterion for performing the RVQoE reporting has occurred during the time period of observation is performed during the time period of observation.

In an embodiment, the triggering criterion specifies a threshold number of occurrences of a triggering event during the time period of observation.

In an embodiment, the time period of observation is single period of time.

In an embodiment, the time period of observation is a period of time that reoccurs at predetermined intervals.

In an embodiment, the time period of observation is associated with a reporting periodicity of the UE.

In an embodiment, the time period of observation is associated with a period of activity of the UE.

In an embodiment, the receiving the RVQoE configuration occurs subsequent to providing, to the network node, UE capability information.

In an embodiment, a UE for performing conditional event-based RVQoE reporting can include radio circuitry and processing circuitry configured to receive, from a network node, an RVQoE configuration that indicates a time period of observation and a triggering criterion for performing RVQoE reporting, determine that the triggering criterion for performing the RVQoE reporting has occurred during the time period of observation, and provide, to the network node, an RVQoE report indicating that the triggering criterion has occurred during the time period of observation.

In another embodiment, a method performed by a network node for configuring RVQoE reporting can include providing, to a UE an RVQoE configuration that indicates a time period of observation and a triggering criterion for performing RVQoE reporting and receiving, from the UE, an RVQoE report indicating that the triggering criterion has occurred during the time period of observation.

In an embodiment, the providing the RVQoE configuration is in response to receiving UE capability information from the UE indicating that the UE can perform RVQoE reporting.

In an embodiment, the RVQoE report further comprises triggering criterion information that comprises measurement information associated with the triggering criterion.

In an embodiment, a network node for configuring conditional event-based RVQoE reporting can include radio circuitry and processing circuitry configured to provide, to a UE an RVQoE configuration that indicates a time period of observation and a triggering criterion for performing RVQoE reporting and receive, from the UE, an RVQoE report indicating that the triggering criterion has occurred during the time period of observation.

An advantage of the techniques disclosed herein can include enabling significantly reduced signaling over the air interface and reporting RVQoE to the network only when the improvement of the quality of experience is needed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a diagram of a series of threshold based events in a time period of observation in accordance with some embodiments of the present disclosure;

FIG. 2 is another diagram of a series of threshold based events in a time period of observation in accordance with some embodiments of the present disclosure;

FIG. 3 is a message sequence chart for configuring Radio Access Network Visible Quality of Experience (RVQoE) in accordance with some embodiments of the present disclosure;

FIG. 4 shows an example of a communication system in accordance with some embodiments of the present disclosure;

FIG. 5 shows a User Equipment device (UE) in accordance with some embodiments of the present disclosure;

FIG. 6 shows a network node in accordance with some embodiments of the present disclosure;

FIG. 7 is a block diagram of a host, which may be an embodiment of the host of FIG. 4, in accordance with various aspects of the present disclosure described herein;

FIG. 8 is a block diagram illustrating a virtualization environment in which functions implemented by some embodiments of the present disclosure may be virtualized; and

FIG. 9 shows a communication diagram of a host communicating via a network node with a UE over a partially wireless connection in accordance with some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

There currently exist certain challenge(s). Third Generation partnership Project (3GPP) has discussed threshold- and event-based Radio Access Network Visible Quality of Experience (RVQoE) reporting i.e., the sending of RVQoE reports, triggered by a fulfillment of a condition, which could be an occurrence of an RVQoE event, or a measurement result reaching some threshold. Currently, the RVQoE reporting is done periodically from a User Equipment (UE) to Radio Access Network (RAN), where the RVQoE results are reported without any prior evaluation by the UE of whether it is meaningful to report this to RAN. This way, RAN may be receiving reports where RVQoE values indicate that the quality of experience is good, and no action by RAN needs to be taken for the improvement of these conditions. This results in excessive signaling over the air interface. 3GPP has acknowledged the purpose of the trigger-based RVQoE reporting is to improve the quality of experience for the user, but it is unclear how it could be used with minimum resource usage and maximum efficiency.

Certain aspects of the disclosure and their embodiments may provide solutions to these or other challenges.

The present disclosure relates to a method for configuring a User Equipment (UE) to perform conditional trigger-based Radio Access Network Visible Quality of Experience (RVQoE) reporting in a wireless communications system. A network node of a Radio Access Network (RAN) can configure a UE to perform RVQoE reporting when a triggering criterion is met in a time period of observation. A UE Application Layer (AL) can perform the QoE measurements, and then either determine whether the triggering criterion for performing RVQoE reporting has been met based on the measurements, or the UE Application layer can pass the measurements to the UE Access Stratum (AS) layer which can determine whether the triggering criterion has been met. The UE can then provide the RVQoE report to the network node.

The solution proposed herein could be summarized as conditional event based triggered-/threshold-based-triggered RVQoE reporting. In this solution the present disclosure provides enhancements of the trigger-based RVQoE configuration and reporting with methods to evaluate RVQoE conditions (for triggering RVQoE reporting) prior to the reporting towards the RAN. The present disclosure introduces a time variable defining a period of time during which the evaluation should take place before the RVQOE reporting may take place.

Here, a UE receives a configuration from the network, according to which the UE application layer, or both the UE AS and the UE application layers, should collect the RVQoE measurements for a given observation time, provided in the RVQoE configuration secondly, as stipulated by the configuration, the UE AS, or the UE application layer, or both the UE AS and the UE application layer, evaluate the values of those RVQoE measurements according to the reporting triggering conditions provided in the RVQoE configuration. Finally, if the configured conditions are met, the UE AS sends a report or a message to the network, which indicates to the network explicitly or implicitly, that it needs to reallocate radio resources to improve quality of experience.

In the proposed solution, the RVQoE configuration is enhanced to indicate the period of observation during which the UE AS should be collecting the RVQoE reports from the UE application layer, as well as the required number of condition fulfillments for the RVQoE reporting to take place, which would function as a condition to be met to trigger the UE AS to report RVQoE measurements to the RAN.

Certain embodiments may provide one or more of the following technical advantage(s). This solution enables us to significantly reduce signaling over the air interface and report RVQoE to the network only when the improvement of the quality of experience is needed.

A network node can be a RAN node such as a gNB (in a 5G system) or an eNB (in an LTE system), or any type of base station device, central unit, distributed unit, or other node in a RAN.

The terms “application layer measurement configuration”, “application measurement configuration”, “QoE measurement configuration”, “QoE configuration”, “QoE measurement and reporting configuration” and “QoE Measurement Collection (QMC) configuration” are used interchangeably. But note that the “QMC configuration file” is not an equivalent term, but instead refers to the part of the QoE configuration consisting of an XML file containing instructions of QoE metrics to be collected etc.

The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.

The terms “QoE configuration” and “QoE measurement configuration” are used interchangeably. Similarly, the terms “RVQoE configuration” and “RVQoE measurement configuration” are used interchangeably.

The terms “access stratum” and “radio layer” are used interchangeably when referring to a UE.

The solution is presented on the example of a UE in dual connectivity, but it also may apply to radio access technologies where the UE is served by more than two connectivity legs.

The solution proposed in the present disclosure applies to New Radio (NR) as well as future Radio Access Technologies (RATs) such as 6G, with the Integrated Access Backhaul Mobile Terminal (IAB-MT) a parent backhaul link terminating function and the IAB Donor Unit (IAB-DU) an access service providing function of a relay node.

“Sending reports to a node” may or may not mean that the said node is the consumer, i.e., the end destination of the reports.

The terms “node” and “network node” are used interchangeably herein.

The term “triggered reporting” applies to both threshold- and event-based reporting.

The terms “reporting triggers”, “triggers” and “triggering conditions”, are used interchangeably. In other words, unless explicitly stated otherwise, they apply to both threshold- and event-based reporting triggers.

The terms “reporting condition” and “reporting triggering condition” are used interchangeably.

The solution herein is presented on the example of RVQoE but is equally applicable to QoE measurements and reporting as well.

The terms “Time of observation”, “Observation time”, “Observation period” and

“Period of observation” are used interchangeably.

If the “prerequisite number of condition fulfillments for the RVQoE reporting to take place” equals X, this means that, if condition is fulfilled X+1 times, the reporting should occur.

The “Maximum number of condition fulfillments” is not equal to the threshold-based condition.

RVQoE measurement periodicity in this solution differs from the RVQoE reporting periodicity.

The terms “UA AS”, “AS”, “UE AS layer” and “AS layer” are used interchangeably.

The present disclosure distinguishes reporting and identify a couple of types of reporting: (1) Reporting from the UE application layer to the UE AS layer, (2) Reporting from the UE AS layer to the RAN. Contents of those two types of reports in this solution may differ.

The terms “RVQoE value” and “RVQoE metric's value” are used interchangeably and refer to a value obtained upon the measurement of an RVQoE metric at the application layer.

The present disclosure is discussed with respect to the buffer level RVQoE metric, but it may be generalized to other RVQoE metrics, where the reporting condition may consist of several sub-conditions, where each sub-condition may pertain to the same or different RVQoE metric as the other sub-conditions. In this case, all or some of the sub-conditions should be fulfilled for the reporting to take place.

Conditional Reporting from UE AS to RAN (Variant 1)

This section describes aspects of the proposed solution in terms of a number of steps described in the subsections below. At step 2, the sequence of steps diverges into an “a” track and a “b” track. Then, at step 3, each track diverges further into multiple sub-tracks.

### RVQoE Configuration Aspects (Step 0)

The RVQoE configuration is to be enhanced with the parameter “Time of Observation” (or equivalently, “Period of Observation”, or “Observation period”). The “Time of observation” is used for the conditional reporting of RVQoE measurements to the RAN.

The Time of observation may be a repetitive time period (i.e., when one time period ends, a next time periods one starts (i.e., contiguous repetitive time periods)).

As another option, the Time of observation may be a repetitive time period with a gap after the end of each time period until the next time period starts.

As yet another option, the Time of observation may be a single (one-time) time period, with a predefined duration.

As yet another option, the Time of observation may be a sliding time window.

As yet another option, the period duration is not predefined, but rather the period is terminated ad hoc by the UE. So, in this case, the UE explicitly indicates to the UE the beginning and the end of the period.

In one variant, applicable for all evaluation criteria proposed in the present disclosure, a prerequisite for the evaluation of reporting criteria is that, during the observation period, there exists incoming data for the application session. So, for the buffer level to be evaluated, there needs to be incoming data at the UE. This implies that, in some variants, the observation period may be paused during the periods of session inactivity at the UE.

In one variant, the RAN explicitly indicates to the UE to pause the countdown of the time for an observation period. A pause can be, for example, announced for periods when there is no incoming data for the application session.

In another variant, the RAN instructs the UE to pause the evaluation when the session playout is paused.

In one variant, the pausing of evaluation is applied only for the reporting threshold criterion “buffer level below value X”. In other variants, it applies to criteria “buffer level below value X” or “buffer level between values X and Y”.

The UE AS receives the RVQoE measurements performed by the UE application layer during the “Time of observation” and determines whether the reported results, and/or one or more other indication(s) associated with the reported results, are to be sent to the RAN. Alternatively, the UE application performs a number of measurements during the Time of observation and determines itself whether to send the results, and/or one or more other indication(s) associated with the measurement results, to the UE AS for further delivery to the RAN.

In more general terms, the “Time of Observation” is used to provide an aggregated view for a set of RVQoE measurements, so that UE reports to the RAN information expressing one or more properties of the set of RVQoE measurements. In the main aspect covered by this disclosure, the “Time of Observation” is used by the UE AS to indicate whether a certain number of RVQoE metric values fulfil a certain criterion (e.g., N instances of the buffer level have a value below a certain threshold, or above a certain threshold).

In one variant, the information being reported is an indication of the number of instances of RVQoE metric whose values have fulfilled a certain criterion (e.g., the UE AS received “M” instances of the buffer level with value above a threshold- or below a threshold).

In another variant, the information being reported is an indication of the number of instances of an RVQoE metric whose values have NOT fulfilled a certain criterion.

In another variant, the information being reported comprises two indications, one indication representing the number of instances of an RVQoE metric whose value have fulfilled a certain criterion, and another indication representing the number of instances of an RVQoE metric whose value have NOT fulfilled a certain criterion.

In another variant, the information indicates whether, within the Time of Observation, the values of an observed RVQoE metric were fluctuating in a way that some instances fulfilled a criterion, and some other instances did not fulfil the same criterion. For example, if the criterion is: “buffer level values >threshold1” (or “buffer level values <threshold2”), and the information is a flag set to a certain value (e.g., 0) or absent to indicate that all buffer level values observed during the “Time of Observation” fulfilled the criterion, otherwise, the flag is set to another value (e.g., 1) to indicate that some (but not all) of the RVQoE metric values—in the example the buffer level values-fulfilled the criterion, but not all. In a sub-variant, the indication (e.g., the flag) is used to indicate whether at least the majority of values of the observed RVQoE metric during the Time of Observation fulfilled the criterion (alternatively whether they did not fulfill the criterion).

In another variant, the information provided indicates whether the values of an observed RVQoE metric have always (across the Time of Observation) fulfilled a criterion (e.g., whether all the values of the observed buffer level have been always below a first threshold, or higher than a second threshold, or between a first threshold and a second threshold, or outside a range defined by a first threshold and a second threshold.

In yet another variant, the information being reported comprises a series of indications (e.g., implemented as a bitmap), where the i-th element of the series indicates the i-th instance of an RVQoE metric value and the i-th value indicates whether the i-th instance of the RVQoE metric value has fulfilled or has NOT fulfilled a certain criterion.

In yet another variant, the information being reported comprises measurement results on a set of RVQoE metrics being configured in the RVQoE configuration, which may include:
any of the RVQoE metrics that are specified for the service type that is being measured on,
any of the above-described indications (value(s) or bitmap(s)) of the number of measured instances of a certain RVQoE metric value which fulfilled a certain criterion (e.g., being below (and optionally equal to) a threshold),
any of the above-described indications (value(s) or bitmap(s)) of the number of measured instances of a certain RVQoE metric value which did not fulfill the certain criterion (e.g., being above (and optionally equal to) a threshold),
and wherein the certain RVQoE metric's values in relation to the certain criterion is what the UE measures during the time of observation to determine if a triggering condition is fulfilled, e.g., a triggering condition for sending an RVQoE report including the described information.

In yet another variant, the information being reported is only that the triggering condition has been fulfilled (where the triggering condition is based on the previously described principle of monitoring one or more RVQoE metric measurement values in relation to a criterion during an Observation period).

Such an RVQoE report may as one option be an empty RVQoE report.

Another option is that the RVQoE report contains an indication of that it was triggered by fulfillment of a triggering condition, and optionally which triggering condition it was (e.g., indicated by a triggering condition identifier, a triggering condition index or an ENUMERATED value identifying the triggering condition). This also applies in case the condition for reporting consists of several sub-conditions, where each of these conditions may pertain to the same or different RVQoE metric as the other sub-conditions.

In one variant, which can be combined with the other described variants and alternative, the Time of Observation is not reset (or alternatively it is reset) when at least one value of an observed RVQoE metric does not fulfil the criterion.

In addition, RVQoE configuration may contain a “prerequisite number of condition fulfillments for the RVQoE reporting to take place”. This number would act as a condition for the UE AS to report to RAN or for the UE application to report to the UE AS for further delivery of the RVQoE report to the RAN. That is, if the number of times that the UE AS, or UE application, evaluated that the reported RVQoE metric value fulfilled the condition exceeds the “prerequisite number of condition fulfillments for the RVQoE reporting to take place” configured by the RAN, the UE AS, or the UE application, should report to the RAN at least one of: that the number of condition fulfillments, or a message/indication that “RVQoE metric fulfilled the condition”, or any of the previously described variants of information that may be reported.

### Evaluation of the Trigger for RVQoE Reporting (Step 1)

Upon UE being configured for RVQoE measurements, the UE application layer receives instructions from the UE AS about the RVQoE metrics to be measured, the application layer performs those measurements and reports them to the UE AS.

(Step 1.a) As one option, the UE application layer would only measure the RVQoE metric value(s) at a given measurement periodicity and without any evaluation of whether the RVQoE report triggering event has occurred, would forward the obtained value(s) (and optionally other measurement results no related to the evaluation of the reporting condition fulfillment) directly to the UE AS layer, and the UE as layer does the evaluation.

In one variant, the same parameter controlling the periodicity at which the UE application layer measures and/or reports the RVQoE metrics when the RVQoE reporting is based on conditions, is the same as also controlling the reporting of RVQoE measurements when such reporting is not based on condition.

In another variant, two separate parameters (potentially with the same value) are used, i.e., the configuration for the UE that controls the reporting of RVQoE measurements based on condition(s) is separated from the reporting of RVQoE measurements not based on condition(s).

In another variant, the periodicity to be used for RVQoE reporting is not specified by RAN, and the RVQoE metrics are reported according to the periodicity specified for QoE (e.g., as defined in the Container for Application Layer Measurement Configuration IE in NGAP 38.413 v17.4.0).

(Step 1.b) As another option, the UE Application layer could directly evaluate whether the RVQoE reporting triggering condition was fulfilled before sending the measured value(s) (and/or optionally other measurement results no related to the evaluation of the reporting condition fulfillment) to the UE AS.

Reporting from UE Application Layer to UE AS (Step 2)

A prerequisite for this step is that the condition for reporting has been fulfilled.

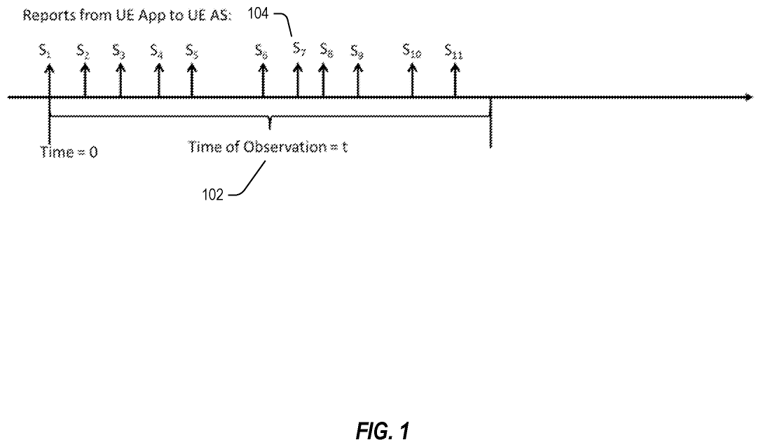

(Step 2.a) Following the Step 1.a, without any preference or selection, the UE application layer sends the collected RVQoE metric value(s) to the UE AS layer as long as the “Time of observation” has not expired, as shown in the figure below. The measurement at the application may be periodic, as defined in the RVQoE configuration, and hence reporting to the UE AS layer may also be periodic. However, the reporting to the RAN may or may not be periodic. FIG. 1 is a diagram of a series of threshold based events (e.g., 104) in a time period of observation 102 in accordance with some embodiments of the present disclosure.

Note that for the case of “Time of observation” in the form of contiguous repetitive time periods or a sliding time window, the UE application layer may continuously send collected RVQoE metric values to the UE AS layer for the duration of the application session or for the duration of the RVQoE measurement session. In FIG. 1, below, S1, S2, . . . . S11 are different values of an RVQoE metric included in one RVQoE report. However, another option is to divide the values (i.e., samples) S1, S2, . . . . S11 into multiple RVQoE reports.

(Step 2.b) Following the Step 1.b, UE application layer may report to the UE AS only those RVQoE metric values which fulfill the RVQoE reporting condition. In this case the UE application layer also needs to indicate the sequence number of each sample, e.g., “4th and 8th measured value have fulfilled the condition”. This may lead to UE AS receiving aperiodic reports from the UE application layer as some of even periodically measured metric values may not fulfill the RVQoE reporting condition and hence would not be reported to the UE AS. As an alternative, the UE application layer may in a single report to the UE AS (e.g., in a single AT command, such as a +CAPPLEVMRNR AT command) include all the RVQoE metric values that fulfilled the RVQoE reporting condition and which were measured during the Time of observation.

Optionally, the UE application layer does not only report values of the RVQoE metric(s) that is (are) subject to the evaluation of fulfillment of the reporting triggering condition, but also the measurement values associated with other RVQoE metrics for which measurements have been configured.

As another option, the UE application layer does not report values of RVQoE metric(s) that is (are) subject to evaluation of fulfillment of the reporting triggering condition, but only reports measurement values associated with other RVQoE metrics for which measurements have been configured.

As yet another option, the UE application layer only reports an indication that the RVQoE reporting condition has been fulfilled, wherein this indication optionally may indicate which triggering condition it was (e.g., indicated by a triggering condition identifier, a triggering condition index or an ENUMERATED value identifying the triggering condition).

Evaluation of the Measurement Reports Arriving from UE Application Layer to UE AS Layer (Step 3)

(Step 3.a.1) Following the step 2.a, as an option, the UE AS layer evaluates a RVQoE report from the UE application layer when it arrives, since the UE AS already knows the RVQoE reporting triggering condition, e.g., event or threshold condition, as it was provided in the RVQoE configuration. E.g., as the value Si arrives to UE AS, the UE AS compares that value with the condition, e.g., compares the value with the event or threshold. If the condition is fulfilled, e.g., if the event or threshold condition is fulfilled, the UE AS performs one or more of the following:

(Step 3.a.1.1.a) Add 1 (i.e., +1) to a condition fulfillment counter, e.g., event or threshold counter, when the value Si fulfills the condition (for clarity, nothing is added when the condition not fulfilled)

At the end of the observation period, the UE AS then will have a total number N (i.e., the value of the condition fulfillment counter), indicating how many times the condition was fulfilled, e.g., how many times the event has happened or the threshold was reached, during the time of observation.

Optionally, if the value N is greater than (or alternatively is equal to or greater than) a configured threshold serving as the RVQoE reporting condition, the UE AS sends an RVQoE report to the RAN, including in the RVQoE report any of the previously described options and alternatives for the RVQoE report content.

(Step 3.a.1.1.b) Add 1 (i.e., +1) to a condition fulfillment counter, e.g., event or threshold counter when the value Si fulfills the condition or subtract 1 (i.e., −1) from the condition fulfillment counter, e.g., event or threshold counter, for every Si value in the list received from the UE application layer, which does not fulfill the condition.

(Step 3.a.1.1.c) Add 1 (i.e., +1) to a condition fulfillment counter, e.g., event or threshold counter, when the value Si fulfills the condition, or reset the condition fulfillment counter, e.g., event or threshold counter if the Si value does not fulfill the condition.

(Step 3.a.1.1.d) Keep a status of the condition, e.g., a status of the event or threshold, as “fulfilled” (or set the condition status to “fulfilled” if it did not already have the value “fulfilled”) when the Si value fulfills the condition, or reset (or keep) the status of the condition, e.g., event or threshold status, as “not fulfilled” if the Si does not fulfill the condition.

(Step 3.a.1.2) Associate a timestamp with the Si value and keep the value of the Si in the report (e.g., a value of a buffer level, if it is a buffer level metric that is being measured by the UE application layer) with its timestamp.

(Step 3.a.2) As another option, following the step 2.a, the UE AS collects all the RVQoE metric values received from the UE application layer during the observation period, and perform the evaluation once the “Time of observation” has finished by performing one or more of the following:

(Step 3.a.2.1.a) Add 1 (i.e., +1) to a condition fulfillment counter, e.g., event- or threshold-counter, for every Si in the collected list, which fulfills the condition (for clarity, nothing is added when the condition is not fulfilled)

As an example, the UE AS compares every value Si with a condition configured by the RAN (and provided in the RVQoE configuration), e.g. denoted as SRAN, which e.g. may be a threshold, e.g., a buffer level threshold, wherein the SRAN condition is fulfilled if the value Si is below the threshold (or alternatively if the value Si is equal to or below the threshold), or alternatively if the value Si is above the threshold (or alternatively if the value Si is equal to or above the threshold).

After the evaluation, the UE AS then will have a total number S, indicating how many times the SRAN condition has been fulfilled during the time of observation.

Optionally, if the value S is greater than (or alternatively is equal to or greater than) a configured threshold serving as the RVQoE reporting condition, the UE AS sends an RVQoE report to the RAN, including in the RVQoE report any of the previously described options and alternatives for the RVQoE report content.

(Step 3.a.2.1.b) as an alternative to Step 3.a.2.1.a, add 1 (i.e. +1) to a condition fulfillment counter, e.g. event- or threshold-counter, for every Si in the collected list, which fulfills a condition (e.g. a condition denoted as SRAN), which is configured by the RAN and provided in the RVQoE configuration, or subtract 1 (e.g. −1) for every Si in the collected list, which does not fulfill the SRAN condition

(Step 3.a.2.1.c) as an alternative to Step 3.a.2.1.a, add 1 (i.e. +1) to a condition fulfillment counter, e.g. event- or threshold-counter, for every Si in the collected list, which fulfills a condition (e.g. a condition denoted as SRAN), which is configured by the RAN and provided in the RVQoE configuration, or reset the condition fulfillment counter, e.g. event- or threshold counter, if the Si in the collected list does not fulfill the condition (e.g. the SRAN condition)

(Step 3.a.2.2) Associate a timestamp with each received RVQoE metric value (representing the time when the value was received or when it was collected) and arrange the received RVQoE metric values with their timestamps into a list (which optionally subsequently may be sent to the RAN, e.g., in a MeasurementReportAppLayer message.

The timestamps may have been received from the UE application layer together with the RVQoE metric values, or they may be created and assigned by the UE AS.

(Step 3.b) following the step 2.b, the UE AS may:

(Step 3.b.1a) As one option, assign the value “1” for each received RVQoE metric value, as it already fulfills the RVQoE reporting condition and sum those “1”s to obtain S, a total number of times that the condition to trigger the RVQoE reporting was met during the period of observation. (Note that this is equivalent to using a condition fulfillment counter, which is increased by one for each of the values received from the UE application layer.)

(Step 3.b.2) As another option, associate a timestamp with each received RVQoE metric value and arrange the received RVQoE metric values with their timestamps into a list to be sent within the MeasurementReportAppLayer message.

The timestamps may have been received from the UE application layer together with the RVQoE metric values, or they may be created and assigned by the UE AS.

Reporting from the UE AS to the RAN (Step 4)

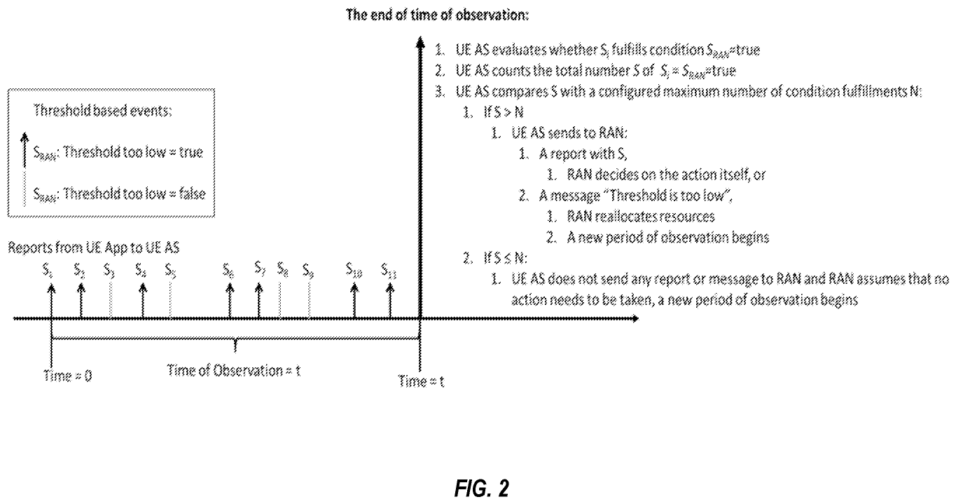

FIG. 2 illustrates an example of a sequence of steps 1-3. In this example, the UE AS performs the condition fulfillment evaluation for the measurement values, i.e., it is an example of the “a” track.

(Step 4.a) Following steps 3.a.1.1, 3.a.2.1, and 3.b.1, in which the UE AS computes a number S, that is a total number of times that the RVQoE report triggering condition has been met in the observation period. A UE may be provided with a condition, e.g., a threshold in the form of a number N configured by the RAN, which is equal to a prerequisite number of condition fulfillments during the observation period allowed without triggering an RVQoE report. Hence, the UE AS layer can decide whether to report to the RAN when comparing N to S. That is, if S exceeds N, the UE AS is triggered to send an RVQoE report to the RAN, and it may report one or more of:
the number S,
a message with the measured RVQoE metric values list,
trigger to send a message as an example, if the buffer level was measured as an RVQoE metric, saying e.g., “Buffer level is too low” or “Buffer level is too high”, depending on whether the condition for reporting to be triggered was set below or above the configured certain threshold, respectively.
any of the above and/or any of the herein previously described potential/optional parameters, values, metrics and/or indications (which are options for inclusion in the RVQoE report), including also measurement value(s) of one or more other RVQoE metric(s) for which measurement has been configured.

(Step 4.b) Following step 3.a.1.2, 3.a.2.2, or 3.b.2, where the UE AS arranges the RVQOE metric's values into a list according to their associated timestamps. In this step, the UE AS can determine a total number, S, of the RVQoE metric values in the list and depending on the total number S, i.e., whether it is smaller or larger than N (i.e., the prerequisite number of condition fulfillments during the observation period which does not trigger an RVQoE report), report that list to RAN. In the case that the RVQoE report is sent, upon its reception, the RAN would decide on its possible actions with respect to the resource optimization (and/or other modifications of configuration parameters or scheduling parameters) for the reporting UE.

Reporting from the UE AS to the RAN Before the Period of Observation Ends (Another Option)

Following the steps where the UE AS immediately receives RVQoE reports from the UE application layer, the UE AS is able to keep track of how many times the condition for triggering RVQoE reporting has been fulfilled. This way, the UE AS can immediately observe when a certain number S of those incoming reports becomes equal to and then exceeds the RAN given number, N (i.e., the prerequisite number of condition fulfillments during the observation period which does not trigger an RVQoE report). In this option, the UE AS may be allowed to report (and may report) to the RAN as soon as either S becomes equal to N+1 (or optionally when S becomes equal to N (with a modified definition of N). This option enables a UE to report to the RAN as soon as the quality of experience deteriorates without needing to wait until the period of observation ends. This enables the RAN to act sooner and reallocate the resources or perform other actions faster. In this option, the period of observation does not need to be complete. A new period of observation may be started as soon as UE AS sends the report to the RAN.

In one variant, the way according to which the UE AS counts the number of incoming reports fulfilling the condition for triggering RVQoE reporting is such that all the received reports are considered (total number of incoming reports during a period of observation).

In this variant the number S is reset to 0 at the beginning of the period of observation and increased every time a new incoming report fulfils the condition of triggering the RVQoE reporting.

In another variant, the way according to which the UE AS counts the number of incoming reports fulfilling the condition for triggering RVQoE reporting is such that only consecutively received reports that fulfil the condition for triggering RVQoE reporting are used for declaring that the trigger for RVQoE reporting is fulfilled. In this variant, the number S is reset to 0 at the beginning of the period of observation, and also every time that, during the period of observation, a report is received which does not fulfil the condition for triggering RVQoE reporting. The number S is increased every time a new incoming report fulfils the condition of triggering the RVQoE reporting.

In another variant, the way according to which the UE AS counts the number of incoming reports fulfilling the condition for triggering RVQoE reporting is such that all received reports are considered, but the received reports have different weights depending on whether they fulfil the condition for triggering RVQoE reporting or not. In this variant, the number S is reset to 0 at the beginning of the period of observation. Further, the number S is increased every time a new incoming report fulfills the condition of triggering the RVQoE reporting, and decreased every time a new incoming report does not fulfil the condition of triggering the RVQoE reporting (with a minimum value of S that can be restricted to 0). Note that this variant requires another condition for sending an RVQoE report from the UE AS to the RAN than the above described prerequisite number of condition fulfillments during the observation period which does not trigger an RVQoE report. For instance, the modified condition may be a threshold for the value of S, where RVQoE reporting from the UE AS would be triggered if S exceeds the threshold (or optionally if S is equal to or greater than the threshold).

### Alternatives for Thresholds Used for RVQoE Reporting

The methods/steps described in the previous sections include examples where the comparison between the values of RVQoE metrics against a threshold is intended to determine if a condition for RVQoE reporting is fulfilled. This comparison may be performed in various ways (i.e., various options), e.g., to verify whether an RVQoE metric value is lower than a threshold, or higher than a threshold, or comprised between a first threshold and a second threshold, or outside a range defined by a first threshold and a second threshold.

RVQoE reporting may be triggered when only one RVQoE metric type has fulfilled the triggering condition according to the methods/steps described above, or it may be a combination of different RVQOE metrics fulfilling the conditions for triggering RVQoE reporting simultaneously.

The UE application layer may evaluate the conditions for RVQoE report triggering for the events and metrics related to and known at the application layer. Such an example is BufferLevel (e.g., the level of the playout buffer in a streaming application).

The UE AS layer may evaluate the conditions for RVQoE report triggering for the radio-related events or metrics. Examples of radio related events: handover, mobility, Dual Connectivity leg changes.

### Duration of Period of Observation

Duration for period of observation is configured by the RAN. This period may be equal to a UE timer, e.g., a timer supervising a radio procedure initiated by the RAN (or initiated by the UE), where the timer is configured to the UE by the RAN, or a time interval) set by the RAN independently of radio procedures, during which the controlled reporting of RVQoE metrics is used.

### Alternatives for Time of Observation

In one alternative approach, the Time of Observation is used by the UE application layer as follows: the UE application receives a Time of Observation together with a (second) Observation period and a third parameter indicating a number X which provides a cap for the number of condition fulfillments observed for a certain RVQoE metric during the second Observation period. Ideally, the relation between the Time of Observation and the (second) Observation period is such that: “(second) Observation period” is strictly larger than (or larger than or equal to) the Time of Observation.

Initially (e.g., as soon as the RVQoE configuration is activated and/or a session for an application starts), the Time of Observation and the (second) Observation period are reset. The Time of Observation is further reset every time that, within the (second) Observation period, the value of an RVQoE metric fulfils the conditions (i.e., the first, second, Nth time that the value of a RVQoE metric fulfil one of the conditions indicated in the present disclosure). For every instance of RVQoE metric fulfilment, a counter (or an internal variable in the UE) is incremented and compared against the number X.

When a number X of fulfillments is observed within the (second) Observation period, the UE application sends one or more of the information described in the present disclosure to the UE AS. Alternatively, and a new cycle begins, i.e., the Time of Observation is reset and the (second) Observation period is also reset.

### RAN Embodiments

In the case that the RAN would receive an RVQoE report from the UE, it should make a decision e.g. on how to optimize or adapt radio resources (and/or other modifications of configuration parameters or scheduling parameters) to improve the quality of experience for that UE, or to strive for an “appropriate” quality of experience (e.g. not “over-serve” the UE at the expense of other UEs in the same cell), or to strive for a fair (equal or weighted) quality of experience for the UEs or a group of UEs in the same cell.

### UE Capability Signaling

For the proposed solution to be executed, the UE needs to indicate to the network that it is capable of reporting condition evaluation and the corresponding reporting according to the variants of this solution.

The UE may indicate its capability in the form of ENUMERATED indication type, where each option contains one standardized variant of the solution.

Alternatively, the capability of supporting different variants of the solution may be indicated in the form of a bitmap, where each bit corresponds to one variant, whereas an example of solution variant could be “capable of supporting RVQoE reporting condition evaluation during a Time of Observation configured by the network”. A bit value of “1” may mean that the variant is supported and value “0” may mean that it is not supported, or vice versa.

Alternatively, the UE may set a binary flag, indicating whether the standardized aspects of this solution. A bit value of “1” may mean that the variant is supported and value “0” may mean that it is not supported, or vice versa.

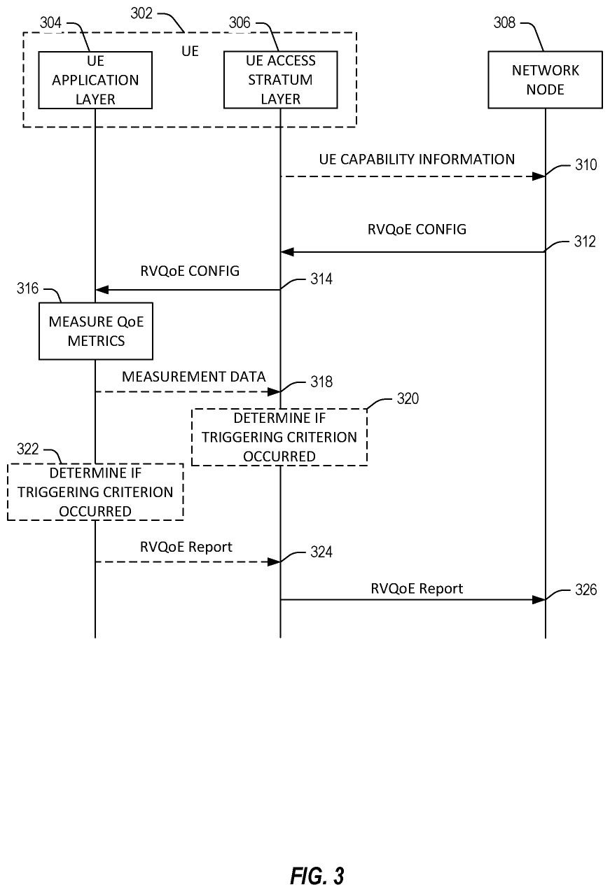

FIG. 3 is a message sequence chart for configuring RVQoE in accordance with some embodiments of the present disclosure as described above in Steps 0 through 4.

For example, a network node 308 can configure a UE 302 to perform the RVQoE reporting, where the UE 302 includes both a UE Application layer 304 and a UE AS 306.

At 310, the UE 302, via the UE AS 306 can optionally provide UE capability information to the network node. The UE capability information can indicate whether the UE can perform RVQoE reporting.

Based on the UE capability information or otherwise, the network node can provide the RVQoE configuration to the UE 302 at step 312. This step corresponds to step 0 as described above.

The RVQoE configuration can indicate a time period of observation and a triggering criterion for performing RVQoE reporting. In an embodiment, the triggering criterion specifies a threshold number of occurrences of a triggering event during the time period of observation. The time period of observation can be either a single period of time or a recurring period of time that reoccurs at regular intervals. In an embodiment, the time period of observation is associated with a reporting periodicity or activity of the UE 302.

At step 314, the UE AS 306 can pass the RVQoE configuration information with time period of observation and triggering criterion to the UE Application layer 304. The UE application layer 304 can then measure the QoE metrics at step 316 (corresponding to step 1.a as described above), and either pass the measurement data to the UE AS at step 318 (corresponding to step 2.a as described above) or determine whether the triggering criterion occurred at step 322 (corresponding to step 1.b as described above), and if the triggering criterion occurred, pass information indicating that the RVQoE triggering criterion occurred to the UE AS 306 at step 324 (corresponding to step 2.b).

The UE AS 306 can also determine, at step 320 (corresponding to step 3.a.1 and/or step 3.a.2) whether the triggering criterion occurred based on the measurement data received at step 318. The UE AS 306 can evaluate whether the triggering criterion occurs as the information is received (step 3.a.1), or once the time period of observation is over (step 3.a.2).

The UE AS 306 can perform the RVQoE reporting and provide the report to the network node at step 326 (corresponding to step 4 and sub-steps).

### Technical Specification Impact

Possible implementations in 3GPP TS 38.331 are shown below in underlined marking.

### 5.3.5.13d Application Layer Measurement Configuration

The UE shall:
1> if measConfigAppLayerToReleaseList is included in appLayerMeasConfig within RRCReconfiguration or RRCResume:
   2> for each measConfigAppLayerId value included in the measConfigAppLayerToReleaseList:
      3> forward the measConfigAppLayerId and inform upper layers about the release of the application layer measurement configuration including any RAN visible application layer measurement configuration;
      3> discard any application layer measurement report received from upper layers;
      3> consider itself not to be configured to send application layer measurement report for the measConfigAppLayerId.
1> if measConfigAppLayerToAddModList is included in appLayerMeasConfig within RRCReconfiguration or RRCResume:
   2> for each measConfigAppLayerId value included in the measConfigAppLayerToAddModList:
      3> if measConfigAppLayerContainer is included for the corresponding MeasConfigAppLayer configuration:
         4> forward the measConfigAppLayerContainer, the measConfigAppLayerId and the serviceType to upper layers considering the serviceType;
      3> consider itself to be configured to send application layer measurement report for the measConfigAppLayerId in accordance with 5.7.16;
      3> forward the transmissionOfSessionStartStop, if configured, and measConfigAppLayerId to upper layers considering the serviceType;
      3> if ran-VisibleParameters is set to setup and the parameters have been received:
         4> forward the measConfigAppLayerId, the ran-VisiblePeriodicity, if configured, the numberOfBufferLevelEntries, if configured, and the reportPlayoutDelayForMediaStartup, if configured, to upper layers considering the serviceType;
         4> forward the timeOfObservation, PreregNoConditionFulfillments, if configured;
      3> else if ran-VisibleParameters is set to release:
         4> forward the measConfigAppLayerId and inform upper layers about the release of the RAN visible application layer measurement configuration;
      3> if pauseReporting is set to true:
         4> if at least one segment, but not all segments, of a segmented MeasurementReportAppLayer message containing an application layer measurement report associated with the measConfigAppLayerId has been submitted to lower layers for transmission:
         5>submit the remaining segments of the MeasurementReportAppLayer message to lower layers for transmission;
         4>suspend submitting application layer measurement report containers to lower layers for the application layer measurement configuration associated with the measConfigAppLayerId;
         4> store any previously or subsequently received application layer measurement report containers associated with the measConfigAppLayerId for which no segment, or full message, has been submitted to lower layers for transmission;
      3> else if pauseReporting is set to false and if transmission of application layer measurement report containers has previously been suspended for the application layer measurement configuration associated with the measConfigAppLayerId:
         4> submit stored application layer measurement report containers to lower layers, if any, for the application layer measurements configuration associated with the measConfigAppLayerId;
         4>resume submitting application layer measurement report containers to lower layers for the application layer measurement configuration associated with the measConfigAppLayerId;
NOTE 1: The UE may discard reports when the memory reserved for storing application layer measurement reports becomes full.
NOTE 2: The transmission of RAN visible application layer measurement reports and appLayerSessionStatus is not paused when pauseReporting is set to true.

The MeasurementReportAppLayer message is used for sending application layer measurement report.
Signalling radio bearer: SRB4
RLC-SAP: AM
Logical channel: DCCH
Direction: UE to Network

### MeasurementReportAppLayer Message

```
-- ASN1START
-- TAG-MEASUREMENTREPORTAPPLAYER-START
MeasurementReportAppLayer-r17 ::= SEQUENCE {
  criticalExtensions CHOICE {
    measurementReportAppLayer-r17 MeasurementReportAppLayer-r17-IEs,
    criticalExtensionsFuture SEQUENCE { }
  }
}
MeasurementReportAppLayer-r17-IEs ::= SEQUENCE {
  measurementReportAppLayerList-r17 MeasurementReportAppLayerList-r17,
  lateNonCriticalExtension OCTET STRING OPTIONAL,
  nonCriticalExtension SEQUENCE{ } OPTIONAL
}
MeasurementReportAppLayerList-r17 ::= SEQUENCE (SIZE (1..maxNrofAppLayerMeas-r17)) OF
MeasReportAppLayer-r17
MeasReportAppLayer-r17 ::= SEQUENCE {
  measConfigAppLayerId-r17 MeasConfigAppLayerId-r17,
  measReportAppLayerContainer-r17 OCTET STRING
OPTIONAL,
  appLayerSessionStatus-r17 ENUMERATED {started, stopped}
OPTIONAL,
  ran-VisibleMeasurements-r17 RAN-VisibleMeasurements-r17
OPTIONAL
}
RAN-VisibleMeasurements-r17 ::= SEQUENCE {
  appLayerBufferLevelList-r17 SEQUENCE (SIZE (1..8)) OF AppLayerBufferLevel-r17
OPTIONAL,
  playoutDelayForMediaStartup-r17 INTEGER (0..30000)
OPTIONAL,
  pdu-SessionIdList-r17 SEQUENCE (SIZE (1..maxNrofPDU-Sessions-r17)) OF PDU-
SessionID OPTIONAL,
  timeOfObservation INTEGER (0..30000) OPTIONAL,
  PrerefNoConditionFulfillments INTEGER (0..30000)
OPTIONAL,
...
}
AppLayerBufferLevel-r17 ::= INTEGER (0..30000)
-- TAG-MEASUREMENTREPORTAPPLAYER-STOP
-- ASN1STOP
```

MeasReportAppLayer field descriptions

appLayerSessionStatus
Indicates that an application layer measurement session in the application layer starts or ends.
measReportAppLayerContainer
The field contains application layer measurement report, see Annex L (normative) in TS 26.247 [68],
clause 16.5 in TS 26.114 [69] and TS 26.118 [70].
ran-VisibleMeasurements
The field contains the configuration of RAN visible application layer measurement parameters.

RAN-VisibleMeasurements field descriptions

appLayerBufferLevelList
The field indicates a list of application layer buffer levels, and each AppLayerBufferLevel indicates
the application layer buffer level in ms. Value 0 corresponds to 0 ms, value 1 corresponds to 10 ms,
value 2 corresponds to 20 ms and so on. If the buffer level is larger than the maximum value of
30000 (5 minutes), the UE reports 30000.
playoutDelayForMediaStartup
Indicates the application layer playout delay for media start-up in ms. Value 0 corresponds to 0 ms,
value 1 corresponds to 1 ms, value 2 corresponds to 2 ms and so on. If the playout delay for media
start-up is larger than the maximum value of 30000 ms, the UE reports 30000.
pdu-SessionIdList
Contains the identity of the PDU session, or the identities of the PDU sessions, used for application
data flows subject to the RAN visible application layer measurements.
timeOfObservation
Indicates the period of time during which the UE application layer or UE AS layer should be
measuring and evaluating the RVQoE measurements against a triggering condition, provided by
gNB, and collecting those measurement reports that fulfill the condition, before sending the RVQoE
report (at the end of this time of observation)
PrereqNoConditionFulfillments
Indicates the prerequisite number of condition fulfillments. This number is provided by the gNB.

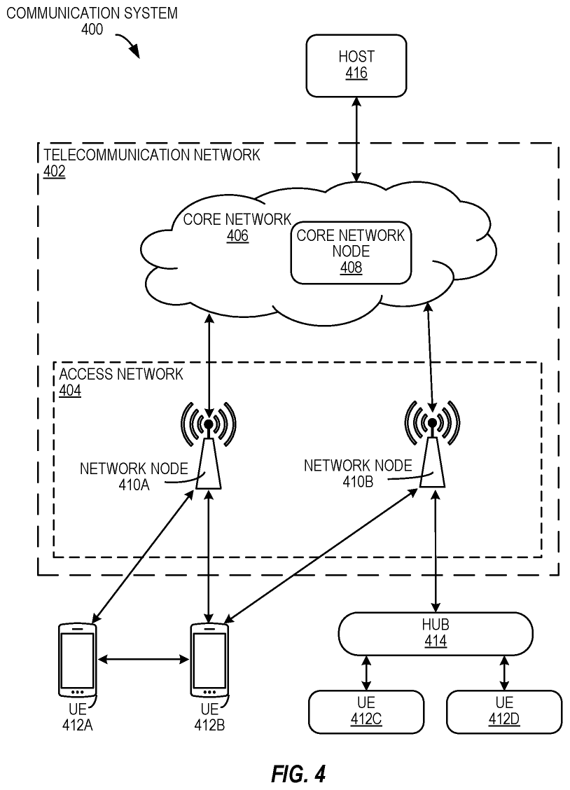

FIG. 4 shows an example of a communication system 400 in accordance with some embodiments.

In the example, the communication system 400 includes a telecommunication network 402 that includes an access network 404, such as a Radio Access Network (RAN), and a core network 406, which includes one or more core network nodes 408. The access network 404 includes one or more access network nodes, such as network nodes 410A and 410B (one or more of which may be generally referred to as network nodes 410), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 402 includes one or more Open-RAN (ORAN) network nodes. An ORAN network node is a node in the telecommunication network 402 that supports an ORAN specification (e.g., a specification published by the O-RAN Alliance, or any similar organization) and may operate alone or together with other nodes to implement one or more functionalities of any node in the telecommunication network 402, including one or more network nodes 410 and/or core network nodes 408.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 410 facilitate direct or indirect connection of User Equipment (UE), such as by connecting UEs 412A, 412B, 412C, and 412D (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402 and may be operated by the service provider or on behalf of the service provider. The host 416 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system 400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 402 is a cellular network that implements 3GPP standardized features. Accordingly, the telecommunication network 402 may support network slicing to provide different logical networks to different devices that are connected to the telecommunication network 402. For example, the telecommunication network 402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-Radio Access Technology (RAT) or multi-standard mode. For example, a UE may operate with any one or combination of WiFi, New Radio (NR), and LTE, i.e., being configured for Multi-Radio Dual Connectivity (MR-DC), such as Evolved UMTS Terrestrial RAN (E-UTRAN) NR-Dual Connectivity (EN-DC).

In the example, a hub 414 communicates with the access network 404 to facilitate indirect communication between one or more UEs (e.g., UE 412C and/or 412D) and network nodes (e.g., network node 410B). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a Virtual Reality (VR) headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular if one or more of the UEs are low energy IoT devices.

The hub 414 may have a constant/persistent or intermittent connection to the network node 410B. The hub 414 may also allow for a different communication scheme and/or schedule between the hub 414 and UEs (e.g., UE 412C and/or 412D), and between the hub 414 and the core network 406. In other examples, the hub 414 is connected to the core network 406 and/or one or more UEs via a wired connection. Moreover, the hub 414 may be configured to connect to a Machine-to-Machine (M2M) service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410B. In other embodiments, the hub 414 may be a non-dedicated hub—that is, a device which is capable of operating to route communications between the UEs and the network node 410B, but which is additionally capable of operating as a communication start and/or end point for certain data channels.

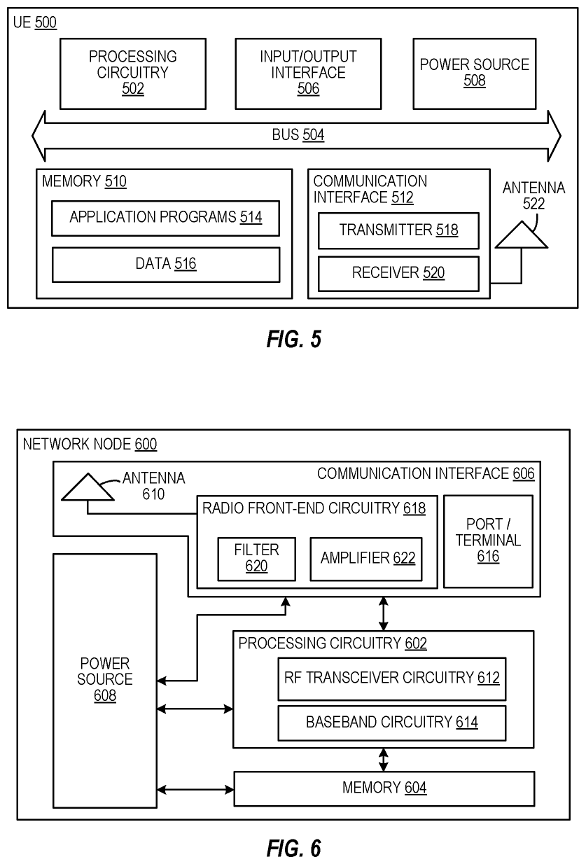

FIG. 5 shows a UE 500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

The UE 500 is an exemplary embodiment of the UE 302 described in FIG. 3 and can perform all of the functionality that UE 302 performs in steps 310 to 326.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 502 may include multiple Central Processing Units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 510 may allow the UE 500 to access instructions, application programs, and the like stored on transitory or non-transitory memory media, to off-load data, or to upload data. An article of manufacture, such as one utilizing a communication system, may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., the antenna 522) and may share circuit components, software, or firmware, or alternatively be implemented separately.

In the illustrated embodiment, communication functions of the communication interface 512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 6 shows a network node 600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

The network node 600 is an exemplary embodiment of the network node 308 described in FIG. 3 and can perform all of the functionality that network node 308 performs in steps 310 to 326.

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes processing circuitry 602, memory 604, a communication interface 606, and a power source 608. The network node 600 may be composed of multiple physically separate components (e.g., a NodeB component and an RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 600 may be configured to support multiple RATs. In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 600.

The processing circuitry 602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 600 components, such as the memory 604, to provide network node 600 functionality.

In some embodiments, the processing circuitry 602 includes a System on a Chip (SOC). In some embodiments, the processing circuitry 602 includes one or more of Radio Frequency (RF) transceiver circuitry 612 and baseband processing circuitry 614. In some embodiments, the RF transceiver circuitry 612 and the baseband processing circuitry 614 may be on separate chips (or sets of chips), boards, or units, such as radio units and digital units. In alternative embodiments, part or all of the RF transceiver circuitry 612 and the baseband processing circuitry 614 may be on the same chip or set of chips, boards, or units.

The memory 604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and the memory 604 are integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. The radio front-end circuitry 618 comprises filters 620 and amplifiers 622. The radio front-end circuitry 618 may be connected to the antenna 610 and the processing circuitry 602. The radio front-end circuitry 618 may be configured to condition signals communicated between the antenna 610 and the processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of the filters 620 and/or the amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface 606 may comprise different components and/or different combinations of components.

In certain alternative embodiments, the network node 600 does not include separate radio front-end circuitry 618; instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes the one or more ports or terminals 616, the radio front-end circuitry 618, and the RF transceiver circuitry 612 as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, the communication interface 606, and/or the processing circuitry 602 may be configured to perform any receiving operations and/or certain obtaining operations described herein as being performed by the network node 600. Any information, data, and/or signals may be received from a UE, another network node, and/or any other network equipment. Similarly, the antenna 610, the communication interface 606, and/or the processing circuitry 602 may be configured to perform any transmitting operations described herein as being performed by the network node 600. Any information, data, and/or signals may be transmitted to a UE, another network node, and/or any other network equipment.

The power source 608 provides power to the various components of the network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid or an electricity outlet) via input circuitry or an interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

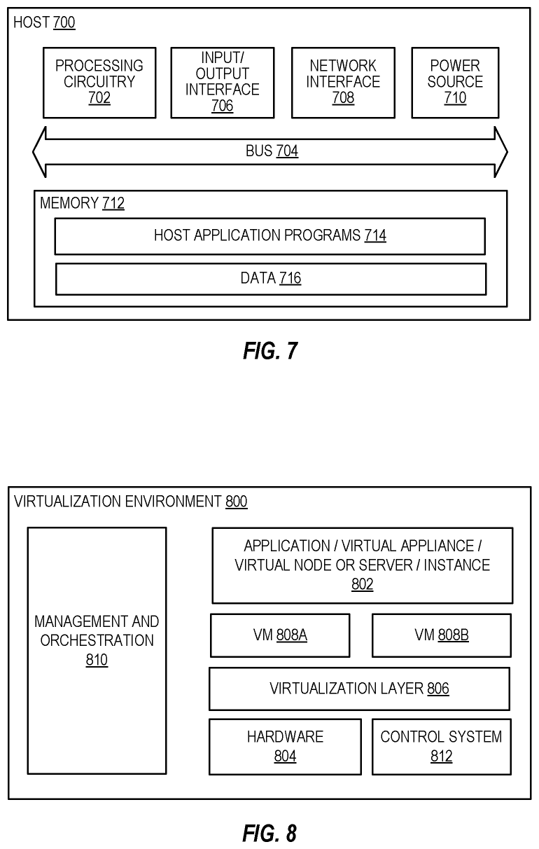

FIG. 7 is a block diagram of a host 700, which may be an embodiment of the host 416 of FIG. 4, in accordance with various aspects described herein. As used herein, the host 700 may be or comprise various combinations of hardware and/or software including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and memory 712. Other components may be included in other embodiments. Features of these components may be substantially similar to those described with respect to the devices of previous figures, such as FIGS. 5 and 6, such that the descriptions thereof are generally applicable to the corresponding components of the host 700.

The memory 712 may include one or more computer programs including one or more host application programs 714 and data 716, which may include user data, e.g. data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 714 may also provide for user authentication and licensing checks and may periodically report health, routes, and content availability to a central node, such as a device in or on the edge of a core network. Accordingly, the host 700 may select and/or indicate a different host for Over-The-Top (OTT) services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 800 includes components defined by the O-RAN Alliance, such as an O-Cloud environment orchestrated by a Service Management and Orchestration Framework via an O-2 interface.

Applications 802 (which may alternatively be called software instances, virtual appliances, network functions, virtual nodes, virtual network functions, etc.) are run in the virtualization environment 800 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or VM Monitors (VMMs)), provide VMs 808A and 808B (one or more of which may be generally referred to as VMs 808), and/or perform any of the functions, features, and/or benefits described in relation with some embodiments described herein. The virtualization layer 806 may present a virtual operating platform that appears like networking hardware to the VMs 808.

The VMs 808 comprise virtual processing, virtual memory, virtual networking, or interface and virtual storage, and may be run by a corresponding virtualization layer 806. Different embodiments of the instance of a virtual appliance 802 may be implemented on one or more of the VMs 808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 808 may be a software implementation of a physical machine that runs programs as if they were executing on a physical, non-virtualized machine. Each of the VMs 808, and that part of the hardware 804 that executes that VM, be it hardware dedicated to that VM and/or hardware shared by that VM with others of the VMs 808, forms separate virtual network elements. Still in the context of NFV, a virtual network function is responsible for handling specific network functions that run in one or more VMs 808 on top of the hardware 804 and corresponds to the application 802.

The hardware 804 may be implemented in a standalone network node with generic or specific components. The hardware 804 may implement some functions via virtualization. Alternatively, the hardware 804 may be part of a larger cluster of hardware (e.g., such as in a data center or CPE) where many hardware nodes work together and are managed via management and orchestration 810, which, among others, oversees lifecycle management of the applications 802. In some embodiments, the hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 812 which may alternatively be used for communication between hardware nodes and radio units.

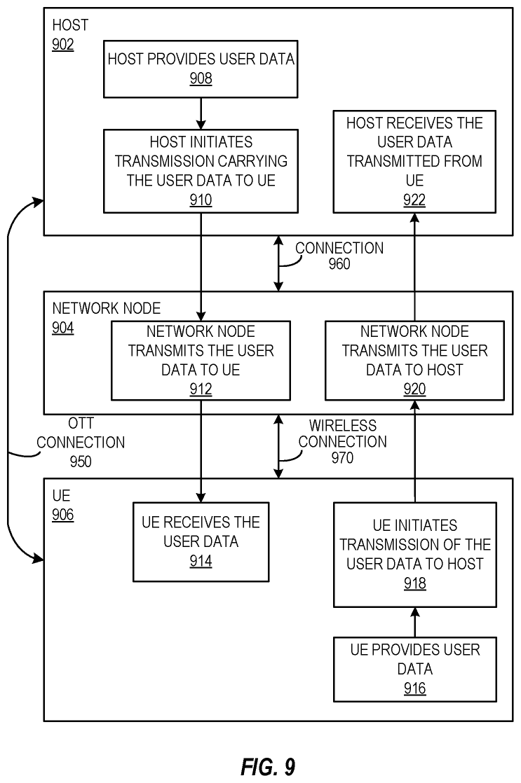

FIG. 9 shows a communication diagram of a host 902 communicating via a network node 904 with a UE 906 over a partially wireless connection in accordance with some embodiments. Example implementations, in accordance with various embodiments, of the UE (such as the UE 412A of FIG. 4 and/or the UE 500 of FIG. 5), the network node (such as the network node 410A of FIG. 4 and/or the network node 600 of FIG. 6), and the host (such as the host 416 of FIG. 4 and/or the host 700 of FIG. 7) discussed in the preceding paragraphs will now be described with reference to FIG. 9.

Like the host 700, embodiments of the host 902 include hardware, such as a communication interface, processing circuitry, and memory. The host 902 also includes software, which is stored in or is accessible by the host 902 and executable by the processing circuitry. The software includes a host application that may be operable to provide a service to a remote user, such as the UE 906 connecting via an OTT connection 950 extending between the UE 906 and the host 902. In providing the service to the remote user, a host application may provide user data which is transmitted using the OTT connection 950.

The network node 904 includes hardware enabling it to communicate with the host 902 and the UE 906. The connection 960 may be direct or pass through a core network (like the core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by the UE 906 and executable by the UE's processing circuitry. The software includes a client application, such as a web browser or operator-specific “app” that may be operable to provide a service to a human or non-human user via the UE 906 with the support of the host 902. In the host 902, an executing host application may communicate with the executing client application via the OTT connection 950 terminating at the UE 906 and the host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via the connection 960 between the host 902 and the network node 904 and via a wireless connection 970 between the network node 904 and the UE 906 to provide the connection between the host 902 and the UE 906. The connection 960 and the wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904 in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR, or AR which it can broadcast, multicast, or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 950 between the host 902 and the UE 906 in response to variations in the measurement results. The measurement procedure and/or the network functionality for reconfiguring the OTT connection 950 may be implemented in software and hardware of the host 902 and/or the UE 906. In some embodiments, sensors (not shown) may be deployed in or in association with other devices through which the OTT connection 950 passes; the sensors may participate in the measurement procedure by supplying values of the monitored quantities exemplified above, or by supplying values of other physical quantities from which software may compute or estimate the monitored quantities. The reconfiguring of the OTT connection 950 may include message format, retransmission settings, preferred routing, etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency, and the like by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some of the embodiments of the present disclosure include the following enumerated embodiments:

Embodiment 1: A method performed by a User Equipment, UE, (302) for performing conditional event-based Radio Access Network, RAN, Visible Quality of Experience, RVQoE, reporting, the method comprising: receiving (312), from a network node (308), an RVQoE configuration that indicates a time period of observation and a triggering criterion for performing RVQoE reporting, determining (320, 322) that the triggering criterion for performing the RVQoE reporting has occurred during the time period of observation; and providing (326), to the network node (308), an RVQoE report indicating that the triggering criterion has occurred during the time period of observation.

Embodiment 2: The method of embodiment 1, wherein the determining further comprises: measuring (316), by a UE Application Layer (304), one or more metrics associated with the triggering criterion; determining (322), by the UE Application Layer (304), based on measurements of the one or more metrics, that the triggering criterion has occurred; and indicating (324), by the UE Application Layer (304), to a UE Access Stratum Layer 306 to provide the RVQoE report to the network node (308).

Embodiment 3: The method of embodiment 2, wherein the indicating further comprises indicating triggering criterion information that comprises measurement information associated with the triggering criterion.

Embodiment 4: The method of any of embodiments 2 to 3, wherein the providing the RVQoE report to the network node (308) is performed by the UE Access Stratum Layer (306), and the RVQoE report indicates that the triggering criterion has occurred.

Embodiment 5: The method of any of embodiment 3, wherein the providing the RVQoE report to the network node (308) is performed by the UE Access Stratum Layer (306), and the RVQoE report indicates that the triggering criterion has occurred, and the RVQoE report comprises the measurement information associated with the triggering criterion.

Embodiment 6: The method of embodiment 1, wherein the determining further comprises: measuring (316), by a UE Application Layer (304), one or more metrics associated with the triggering criterion; and providing (318), by the UE Application Layer (304), measurements of the one or more metrics to a UE Access Stratum Layer (306); and determining (320), by the UE Access Stratum Layer (306), based on the measurements of the one or more metrics, that the triggering criterion has occurred.

Embodiment 7: The method of embodiment 6, wherein the providing the RVQoE report to the network node (308) is performed by the UE Access Stratum Layer (306), and the RVQoE report indicates that the triggering criterion has occurred.

Embodiment 8: The method of embodiment 6, wherein the providing the RVQoE report to the network node (308) is performed by the UE Access Stratum Layer (306), and the RVQoE report indicates that the triggering criterion has occurred, and the RVQoE report comprises the measurement information associated with the triggering criterion.

Embodiment 9: The method of any of embodiments 1 to 8, wherein the determining that the triggering criterion for performing the RVQoE reporting has occurred during the time period of observation is performed after the time period of observation has elapsed.

Embodiment 10: The method of any of embodiments 1 to 8, wherein the determining that the triggering criterion for performing the RVQoE reporting has occurred during the time period of observation is performed during the time period of observation.

Embodiment 11: The method of any of embodiments 1 to 10, wherein the triggering criterion specifies a threshold number of occurrences of a triggering event during the time period of observation.

Embodiment 12: The method of any of embodiments 1 to 11, wherein the time period of observation is single period of time.

Embodiment 13: The method of any of embodiments 1 to 11, wherein the time period of observation is a period of time that reoccurs at predetermined intervals.

Embodiment 14: The method of any of embodiments 1 to 13, wherein the time period of observation is associated with a reporting periodicity of the UE (302).

Embodiment 15: The method of any of embodiments 1 to 14, wherein the time period of observation is associated with a period of activity of the UE (302).

Embodiment 16: The method of any of embodiments 1 to 15, wherein the receiving the RVQoE configuration is in response to providing (310), to the network node (308), UE capability information.

Embodiment 17: A User Equipment, UE, (302) for performing conditional event-based Radio Access Network, RAN, Visible Quality of Experience, RVQoE, reporting, the UE (302) comprising radio circuitry and processing circuitry configured to: receive (312), from a network node (308), an RVQoE configuration that indicates a time period of observation and a triggering criterion for performing RVQoE reporting; determine (320, 322) that the triggering criterion for performing the RVQoE reporting has occurred during the time period of observation; and provide (326), to the network node (308), an RVQoE report indicating that the triggering criterion has occurred during the time period of observation.

Embodiment 18: The UE (302) of embodiment 17, wherein the processing circuitry is further configured to perform any of embodiments 2-16.

Embodiment 19: A method performed by a network node (308), for configuring conditional event-based Radio Access Network, RAN, Visible Quality of Experience, RVQoE, reporting, the method comprising: providing (312), to a User Equipment, UE, (302) an RVQoE configuration that indicates a time period of observation and a triggering criterion for performing RVQoE reporting; and receiving (326), from the UE (302), an RVQoE report indicating that the triggering criterion has occurred during the time period of observation.

Embodiment 20: The method of embodiment 19, wherein the providing the RVQoE configuration is in response to receiving (310) UE capability information from the UE (302) indicating that the UE (302) can perform RVQoE reporting.

Embodiment 21: The method of any of embodiments 19 to 20, wherein the RVQoE report further comprises triggering criterion information that comprises measurement information associated with the triggering criterion.

Embodiment 22: A network node (308) for configuring conditional event-based Radio Access Network, RAN, Visible Quality of Experience, RVQoE, reporting, the network node (308) comprising radio circuitry and processing circuitry configured to: provide (312), to a User Equipment, UE, (302) an RVQoE configuration that indicates a time period of observation and a triggering criterion for performing RVQoE reporting; and receive (326), from the UE (302), an RVQoE report indicating that the triggering criterion has occurred during the time period of observation.

Embodiment 23: The network node (308) of embodiment 22, wherein the processing circuitry is further configured to perform any of embodiments 20-21.

Those skilled in the art will recognize improvements and modifications to the embodiments of the present disclosure. All such improvements and modifications are considered within the scope of the concepts disclosed herein.

1. A method performed by a User Equipment (UE) for performing conditional event-based Radio Access Network (RAN) Visible Quality of Experience (RVQoE) reporting, the method comprising:
receiving, from a network node, an RVQoE configuration that indicates a time period of observation and a triggering criterion for performing RVQoE reporting;
determining that the triggering criterion for performing the RVQoE reporting has occurred during the time period of observation; and
providing, to the network node, an RVQoE report indicating that the triggering criterion has occurred during the time period of observation.

2. The method of claim 1, wherein the determining further comprises:
measuring, by a UE Application Layer, one or more metrics associated with the triggering criterion;
determining, by the UE Application Layer, based on measurements of the one or more metrics, that the triggering criterion has occurred; and
indicating, by the UE Application Layer, to a UE Access Stratum Layer to provide the RVQoE report to the network node.

3. The method of claim 2, wherein the indicating further comprises indicating triggering criterion information that comprises measurement information associated with the triggering criterion.

4. The method of claim 2, wherein the providing the RVQoE report to the network node is performed by the UE Access Stratum Layer, and the RVQoE report indicates that the triggering criterion has occurred.

5. The method of claim 3, wherein the RVQoE report comprises the measurement information associated with the triggering criterion.

6. The method of claim 1, wherein the determining further comprises:
measuring, by a UE Application Layer, one or more metrics associated with the triggering criterion; and
providing, by the UE Application Layer, measurements of the one or more metrics to a UE Access Stratum Layer; and
determining, by the UE Access Stratum Layer, based on the measurements of the one or more metrics, that the triggering criterion has occurred.

7. The method of claim 6, wherein the providing the RVQoE report to the network node is performed by the UE Access Stratum Layer, and the RVQoE report indicates that the triggering criterion has occurred.

8. The method of claim 6, wherein the providing the RVQoE report to the network node is performed by the UE Access Stratum Layer, and the RVQoE report indicates that the triggering criterion has occurred, and the RVQoE report comprises the measurement information associated with the triggering criterion.

9. The method of claim 1, wherein the determining that the triggering criterion for performing the RVQoE reporting has occurred during the time period of observation is performed after the time period of observation has elapsed.

10. The method of claim 1, wherein the determining that the triggering criterion for performing the RVQoE reporting has occurred during the time period of observation is performed during the time period of observation.

11. The method of claim 1, wherein the triggering criterion specifies a threshold number of occurrences of a triggering event during the time period of observation.

12. The method of claim 1, wherein the time period of observation is single period of time.

13. The method of claim 1, wherein the time period of observation is a period of time that reoccurs at predetermined intervals.

14. The method of claim 1, wherein the time period of observation is associated with a reporting periodicity of the UE.

15. The method of claim 1, wherein the time period of observation is associated with a period of activity of the UE.

16. The method of claim 1, wherein the receiving the RVQoE configuration occurs subsequent to:
providing, to the network node, UE capability information.

17. A User Equipment (UE) for performing conditional event-based Radio Access Network (RAN) Visible Quality of Experience (RVQoE), reporting, the UE comprising radio circuitry and processing circuitry configured to:
receive, from a network node, an RVQoE configuration that indicates a time period of observation and a triggering criterion for performing RVQoE reporting;
determine that the triggering criterion for performing the RVQoE reporting has occurred during the time period of observation; and
provide, to the network node, an RVQoE report indicating that the triggering criterion has occurred during the time period of observation.

18. (canceled)

19. A method performed by a network node, for configuring conditional event-based Radio Access Network (RAN) Visible Quality of Experience (RVQoE), reporting, the method comprising:
providing, to a User Equipment (UE), an RVQoE configuration that indicates a time period of observation and a triggering criterion for performing RVQoE reporting; and
receiving, from the UE, an RVQoE report indicating that the triggering criterion has occurred during the time period of observation.

20. The method of claim 19, wherein the providing the RVQoE configuration is in response to receiving UE capability information from the UE indicating that the UE can perform RVQoE reporting.

21. The method of claim 19, wherein the RVQoE report further comprises triggering criterion information that comprises measurement information associated with the triggering criterion.

22. A network node for configuring conditional event-based Radio Access Network (RAN) Visible Quality of Experience (RVQoE) reporting, the network node comprising radio circuitry and processing circuitry configured to:
provide, to a User Equipment (UE), an RVQoE configuration that indicates a time period of observation and a triggering criterion for performing RVQoE reporting; and
receive, from the UE, an RVQoE report indicating that the triggering criterion has occurred during the time period of observation.

23. (canceled)
